(19) United States
(12) Patent Application Publication
(10) Pub. No.: US 2007/0159979 A1
(43) Pub. Date: Jul. 12, 2007

(54) SYSTEM AND METHOD FOR DETECTION OF DATA TRAFFIC ON A NETWORK

(75) Inventors: Graham Butler, West Sussex (GB); Leonardo Cerrillo, Berkshire (GB); Monica Cultrera, London (GB); Julian Fellows, Berkshire (GB)

Correspondence Address: Greenberg Traurig, 12th Floor, 1750 Tysons Boulevard, McLean, VA, 22102, US

(73) Assignee: GLT Corporation, South Coast Metro, CA (US)

(21) Appl. No.: 11/612,196

(22) Filed: Dec. 18, 2006

Related U.S. Application Data
(60) Provisional application No. 60/750,831, filed on Dec. 16, 2005.

(51) Int. Cl. H04J 1/16; H04L 12/66

(52) U.S. Cl. 370/244; 370/352

(57) ABSTRACT

Systems and methods are described for detecting data traffic of a specific type, such as voice-over-IP traffic, on a network. A detector connected to the network is used to identify a set of data packets traveling across the network that conform to at least one signature describing data complying with a data transmission protocol. The detector is used to manipulate the set of data packets or create a record of data associated with the set of data packets. Such record can be analyzed or transferred to an external billing system to capture revenue for the transmission of the data.

This application claims priority from U.S. Provisional Patent Application Ser. No. 60/750,831, filed Dec. 16, 2005, which is incorporated herein by reference in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of computer networks, and in particular to novel systems and methods for detection of particular types of data traffic thereon.

### BACKGROUND OF THE INVENTION

Computer networks are known for communicating multiple types of data traffic. For example, a single corporate network may be used to communicate data traffic which comprises data packets that comply with various communications protocols, including, for example, HTTP, FTP, SMTP, UDP, Virtual Private Networking (VPN) protocols, and various Voice over IP (VoIP) protocols.

Port filtering is known for detection and manipulation of certain data traffic on computer networks. This method has been utilized to identify, block, intercept, and/or redirect all data passing through a node on the network based upon the port number associated with the traffic. For example, corporate network administrators have been known to configure routers on their networks so as to block data traffic on all ports except for those associated with legitimate traffic. Such legitimate traffic includes, e.g., traffic using the HTTP, HTTPS, IMAP4, POP3, SMTP, FTP, or DNS protocols.

Simple port blocking or filtering of data traffic by protocol type can lead to unintended blockage of legitimate traffic, and/or the undesireable transmission of illegitimate traffic over the network. For example, because both undesirable peer-to-peer file sharing programs and legitimate DNS traffic can communicate via UDP, simple blocking of all UDP traffic on a network may prevent DNS requests from being transmitted and thereby interfere with outgoing HTTP requests from a workstation or a proxy server on the network.

Network packet analyzers have been used to intercept and analyze various network data traffic. Such analyzers may be used to examine header information associated with packets traveling across a network. Examples of such network packet analyzers include, e.g., the widely available Ethereal software that is distributed and licensed under the GNU general public license.

Unrestricted flow of VoIP traffic is often seen as undesireable by government entities and network administrators. VoIP phones and/or software can be used to communicate in a manner that bypasses government restraints. For example, VoIP traffic typically cannot be accounted for by government entities that tax telephonic communications, and therefore such entities are losing a dramatically increasing portion of their tax revenues due to the proliferation of VoIP. Indeed, certain countries and government authorities have taken measures to block specific types of VoIP traffic, such as SKYPE traffic.

Furthermore, VoIP can be used by criminals to communicate in a manner which is not detected by conventional wiretapping methods used by law enforcement personnel and government agencies that are empowered to monitor telephonic communications.

### SUMMARY OF THE INVENTION

In a preferred embodiment, the invention provides systems and methods for detecting data traffic of a specific type, such as voice-over-IP traffic, on a network. A detector connected to the network is used to identify a set of data packets traveling across the network that conform to at least one signature describing data complying with a data transmission protocol. The detector is used to manipulate the set of data packets or create a record of data associated with the set of data packets. Such record can be analyzed or transferred to an external billing system to capture revenue for the transmission of the data.

The system and method may be used to detect, account for, and/or manipulate any VoIP connection, independent of the transmission means, be it via fiber, copper, satellite, microwave, other wireless means, 3G networks, VoIP networks, sea cables, IP networks, private VPN's, wireless networks 802.11 B/G/N & Wimax networks, and others.

The system and method can be used to record, account for, block, terminate, divert, add/delete information, distort packets, allow or disallow function, add noise, add latency, or add jitter, to data traffic from all or specific IP addresses and/or from all or specific MAC addresses.

The system and method can be injected in a network via a physical tap, a router on the network, one or more inline cards, or a direct feed.

The system and method can be used to transfer data or information about data to any external data device for processing. For example, the system can transfer data or information about the data to an external billing system so that the data flow can be accounted for by taxing authorities or service providers that charge usage fees based upon the amount of data of a particular type flowing across the network or the amount of time that data of a particular type flows across the network. In this respect, the system may create a record of the sender (e.g., who made a call), the recipient, the time duration of data transmission (e.g., the length of a call), and the time of day that the transmission occurred. The system may be used for data billing, e.g., by an ISP to account for subscriber usage in terms of time or volume of data.

As a further example, the system can transfer data or information about the data to forensic systems for forensic analysis or storage. The system and method can be used to transfer data to an external recording system for creating a record of a VoIP conversation, and/or to a voice recognition system for analysis against known voice prints so as to identify a speaker or isolate a particular speaker's voice among large amounts of VoIP traffic.

The system can be used to detect and/or manipulate a variety of data protocols, including but not limited to SIP, H323, Megaco, MGCP, Skinny, SCCP, IAX, and XMPP. The system and method can be used to detect and/or manipulate data from a variety of different soft phone and VoIP software, including those provided by MSN, Vonage, NetMeeting, SKYPE, XLite, Glophone, GoogleTalk, Yahoo, Net2phone, Dialpad, Paket8, Gismo Project, TomatoVine, SpeakEasy, Mediaring, SJPhone.

The system and method can be used to transfer data to an external system in a variety of forms. Examples include various spreadsheet formats (e.g., a CSV or Excel file), raw data, encrypted data, de-encrypted data, or audio data. With respect to encrypted data, such data may be de-encrypted at the detector prior to transmission to an external system or may be transferred to the external system for de-encryption.

While the system and methods are particularly applicable to VoIP traffic, they can also be used to allow/disallow, manipulate or track other data types and protocols. Such data types and protocols include, e.g., text, video, commercial music or films, P2P protocols, any non-VoIP audio protocol, or other network communication protocol that is identifiable using packet inspection techniques such as those discussed below. In this respect, the system and methods can be used to fulfill a security function by only allowing what is required across a network. The system and methods may be used to selectively filter data traffic so as to allow “identified as authorized” traffic and to disconnect “identified as un-authorized” traffic from the network. In this respect, it may be used to allow only authorized protocols to transcend the network, and disconnect other protocols. This selective filtering may be used for filtering VoIP and/or music, video, P2P streaming, or other data types.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows a block diagram illustrating system architecture of the invention in accordance with one embodiment.

FIG. 2 shows a block diagram illustrating an OOAD loop in accordance with certain aspects of the invention.

FIGS. 3a and 3b show diagrams illustrating the components and format of an SCCP message.

FIG. 4 shows a network diagram illustrating communication between call managers.

FIG. 5 shows a block diagram illustrating communications using an IAX protocol.

FIG. 6 shows a diagram illustrating call setup and teardown using IAX.

FIG. 7 shows a diagram illustrating one-way IAX media flow.

FIG. 8 shows a diagram illustrating the structure of an IAX frame.

FIG. 9 shows a table illustrating specified IAX Frame Type values.

FIG. 10 shows a table illustrating specified IAX Control Frame types.

FIG. 11 shows a table illustrating specified IAX Control control frame types.

FIG. 12 shows a diagram illustrating information elements in IAX Control Frames.

FIG. 13 shows a diagram illustrating communications between a caller, a Google Server, and a callee.

### DETAILED DESCRIPTION OF THE PREFERRED EMBODIMENTS

Reference will be made in detail below to the preferred embodiments of the present invention, examples of which are illustrated in the accompanying drawings.

In one embodiment, the invention provides a system and method for real time detection of Voice over IP (VoIP) sessions on a network. Any VoIP protocol can be detected, including SIP, H.323, MEGACO, MGCP, SCCP, Cisco SCCP, IAX, Google Talk, and Skype. Once detected, the unauthorized traffic can be logged and converted into revenue-earning business. Alternatively, once detected, the VoIP traffic can be monitored, blocked, altered, recorded, forensically analyzed, or otherwise used or to control the flow of information from a company or individual.

The invention preferably detects network traffic that complies with a particular data transmission protocol by performing signature analysis of data packets traveling across the network. Signature analysis may be performed in software running one or more detector boxes connected to the network. In a preferred embodiment, the detector comprises a computer or embedded device running a Unix variant operating system, such as Linux, and software for examining data packets traveling across the network. In other embodiments, the detector may comprise a computer or embedded device on any other computer platform, including Microsoft operating systems and Apple operating systems (particularly enterprise editions).

The software utilized for capturing data packets for analysis may be similar in form to that which has been used for detection of network intrusions such as denial-of-service attacks, virus injection, and spam. In this respect, the presence of unauthorized VoIP traffic in a network is similar to the presence of an intrusion in that the traffic is unexpected but not necessarily unwanted. In particular, the software for capturing data packets for analysis may utilize, for example, portions of code from the open-source product distributed under the name “Snort” by the Snort Project (http://www.snort.org). The product is capable of tapping in to a network, detecting attacks, logging data about the attack and generating a response to the attack. The Snort product is capable of being hosted on any platform; it integrates with database and web server products, and is capable of being distributed to support a scalable architecture. It is written in ‘C’ and is very simply controlled and configured at run time by a text-based configuration file and rule set. Being open source, it is supported in development and is thoroughly tested by a range of adopters.

Other technologies for capturing and analyzing data packets include serial insertions into the traffic stream such as those typically found in the QOS/Policy/Firewall communities. However, such technologies typically pose a risk in that they rely on dropping specific packets in the data stream; any failure or drop in performance of the device could therefore affect the traffic stream.

The detector in accordance with one embodiment of the invention passively observes traffic without interfering with the delivery of datagrams. Where a response is required to shut down a specific connection, this can be accomplished by the device becoming active and injecting appropriate packets composed by the invention to turn off the ends of the connection. this feature is supported by the Snort product.

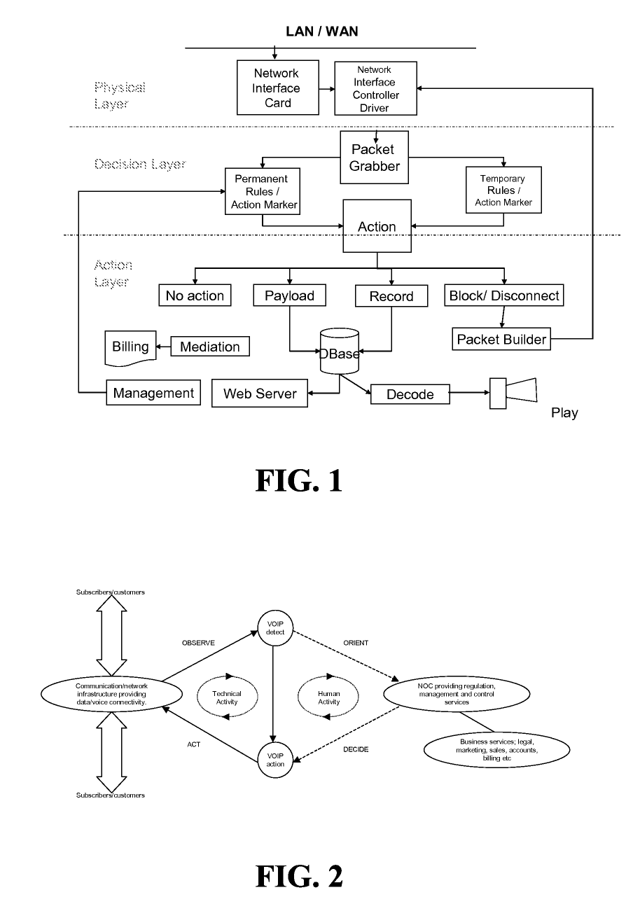

FIG. 1 shows a block diagram illustrating system architecture of the invention in accordance with one embodiment. The architecture supports already established links that the Business Functions and NOC have with the infrastructure, without presenting a risk to any of the pre-existing elements within a customer's architecture.

The invention interfaces with the infrastructure through a stealthy, failsafe configuration; the information product is a simple, standards-compliant object that can be used standalone or integrated into pre-existing or planned information architectures. Stealth is achieved by setting the Network Interface Card in listen-only mode and with no IP or predetermined MAC address.

With reference to FIG. 2, the invention in one embodiment can be represented as an OODA loop that can be used to support the VoIP/unauthorized traffic operations required by business in the telecommunication sector. The system and methods can be used to decompose the basic Observe-Orient-Decide-Act cycle into two sub-loops, technical activity and human activity. It is important to understand, design and configure the system as a support to the human functions, as this is the only way the product will add value and improve the business performance.

The detector in accordance with one embodiment is configured to monitor all IP packets, record only the VoIP packets, and generate a response to be injected into the network to satisfy the action as required for unauthorized traffic. The message injected may mimic the IP, PORT and MAC addresses of the clients, thereby not divulging its presence.

The support provided by the invention for human activity is focused on delivering awareness of the traffic; specifically information that may constitute ‘unauthorized’ traffic presence or traffic which is expected and needs to be metered for billing/admin purposes. Decision-making is supported through maintenance and interpretation of the signatures and actions that need to be taken against grey traffic as a matter of policy.

Not all detected VoIP packets will require positive action. In some cases all that is required is to log the event. The invention may be configured to perform the reverse when used, for example, to detect Skype traffic; the result is the need to derive multiple signature sets from a common root driving independent processes.

As is set forth above, the invention can be configured to detect any VoIP protocol, including SIP, H323, MEGACO, MGCP, SCCP, Cisco SCCP, IAX, Google Talk, and Skype. Design considerations and parameters for configuring the invention to detect the signatures of each of these protocols are set forth below.

SIP Protocol

SIP creates a peer-to-peer communication; to track a call only three different messages are needed:
SIPinvite: when the invite is sent; it is a message where the Request Line contains INVITE.
SIPconnection: when the connection is accepted (the call starts here); it is a message of 200 OK with the field “Cseq: INVITE”.
SIPbye: when the connection is closed (the call terminates here); it is a message where the Request Line contains BYE.

SIP is text based, so to search inside the payload of a message following the SIP protocol, it is enough to search a particular string (such as: “Call-ID:”, “From:”, “To:”) and store the content of the payload from there until it is encountered the new carriage return.

H.323 Protocol

As with SIP, H.323 creates a peer-to-peer communication and again it is possible to track the call with only 3 different messages (same scheme as SIP):
H323invite: its code number is 0x05.
H323connection: its code number is 0x07.
H323bye: its code number is 0x5A.

For message following the H.323 protocol, each piece of information is stored in the body of the information elements, but there is not fixed positions.

The H.323 protocol follows the Q.931 protocol, which structure is:

| | |
|---|---|
| - 8 7 6 5 4 3 2 1 - | |
| - protocol discriminator - | 1 octet |
| - 0 0 0 0 \| length of call ref value - | 2 octet |
| - call reference value - | 3/4 octets |
| - message type - | . . . |
| - code of information element - | |
| - length of information element - | |
| - body of information element - | |
| - .................. - | |

The protocol discriminator is the octet 08 for Q.931, so at the beginning of the routines one should set the pointer at the proper start of the Q.931 section inside the payload. The call reference value may be of 1 or 2 bytes and this is the information that the software may look for in discrimination of different sessions. It depends on message type, which is the possible information element.

The call reference value and following two information elements (IEs) are of interest: “calling party number” and “called party number”. These two IEs are optional for packets where the message type is SETUP. They are not mandatory, so it does not always have these fields. When the fields that are needed are not present, in the output file they are left empty.

MEGACO Protocol

MEGACO is a protocol for communication through gateways, and for this reason to track a call three messages are not enough. It is to be considered that is not possible to see the message sent by or the callee in the same time.

For MEGACO, significant messages to pick up are:
MEGACOinvite_notify (for the caller side): is the first invite sent, it contains information of the phone number dialled, but the call is not created now.
MEGACOinvite_modify (for the caller side): is the message that means number exists, waiting for a response, create a connection.
MEGACOinvite_add (for the callee side).
MEGACOconnection (for the caller side).
MEGACObye (both side).

MEGACO has three possible encodings: pretty text encoding, compact text encoding and binary encoding. Thus, the detector software should include code for detecting all three encodings. The main areas of interest are the “termination ID”, the “context ID” and the IP information inside the look-alike SDP messages. The information is shown and stored in different way for each encoding type.

One significant difference between MEGACO and SIP and H323 is that MEGACO is a gateway protocol, not peer-to-peer. For the “invite” message, there are three different kinds of invite messages to examine to obtain all the information that is needed: invite_notify (with the phone number of the callee), the invite_modify (with the information about the callee) and the invite_add (with the information of the caller, for the callee side). The MEGACOinvite_notify is a NOTIFY message from the caller to the gateway with dd/ce ds=“ . . . ” field, where is stored the phone number. It is a message that notifies the gateway of the occurred event of a digit dialled. The MEGACOinvite_modify is the MODIFY CONNECTION message from gateway to caller, with media field as receive only and with the REMOTE SDP information (about the callee). The MEGACOinvite_add is the ADD CONNECTION message from a gateway to the callee, with all the information about the caller (REMOTE SDP information).

For both the “connection” message and the “bye” message, however, only one message need be examined to obtain all the necessary information. The MEGACOConnection message is the MODIFY message from the gateway to caller with media field changed in sendreceive instead of receiveonly. The MEGACObye message is the SUBTRACT message from gateway to both caller and callee.

MGCP Protocol

As is the case with MEGACO, MGCP is not a peer-to-peer protocol. Thus, we have three different messages for the invite with the same meanings as in MEGACO: invite_ntfy, invite_mdfy and invite_crcx.

The connection phase in MGCP is the modify connection message (mdfy) that change it from recvonly in sendrecv.

The bye phase is the delete connection message (dlcx).

The protocol is encoded with COMMANDS and RESPONSE. Commands: command header and session descriptor info(optional). Response: Response header and session descriptor info(optional).

They are encoded as a set of text lines, separated by a carriage return and line feed character (CRLF) or optional a line feed only. An empty line precedes the session descriptors.

Command header: command line and set of 0 or + parameter lines: command line: 4 items encoded as string of ASCII char, separated by white spaces.
name of request verb,
id of transaction (max 9 decimal digit),
name of endpoints that are to execute the command (up to 255 char),
protocol version (ex. MGCP 1.0).
param lines:
   param name (1 or 2 char),
   colon,
   optional white space,
   param value.
Example:
¦MDCX 1242 card32/1@bla.it MGCP 1.0
¦C: A1234567→it is the “Call ID”: hexadec string (max 32 char)
¦I:FDE→it is the “Connection ID”: hexadec string (max 32 char)
¦M: sendrecv

Response header: response line and optional header that encode the response param
response line: response code (3 digits), white space, transaction ID,
(optional white space+corn)
   Example:
   ¦200 1203 OK
   ¦C: A1234
   ¦N:[128.96.41.12]
      SCCP Protocol

Signaling Connection Control Part (SCCP) is a routing protocol in the SS7 protocol suite, and it provides end-to-end routing for TCAP messages to their proper database. SCCP provides connectionless and connection-oriented network services. The protocol is a set of rules and formats by which the control information (and user data) is exchanged between two peers. The protocol caters for the set-up of logical signaling connection, the release of logical signaling connections, and the transfer of data with or without logical signaling connections.

In SCCP, as in SIP and H323 discussed above, only three messages need be examined to track the call: SCCPinvite, which message type code is CR (Connection Request); SCCPconnection, which message type code is CC (Connection Confirmed); and SCCPbye, which message type code is RLC (Release Complete).

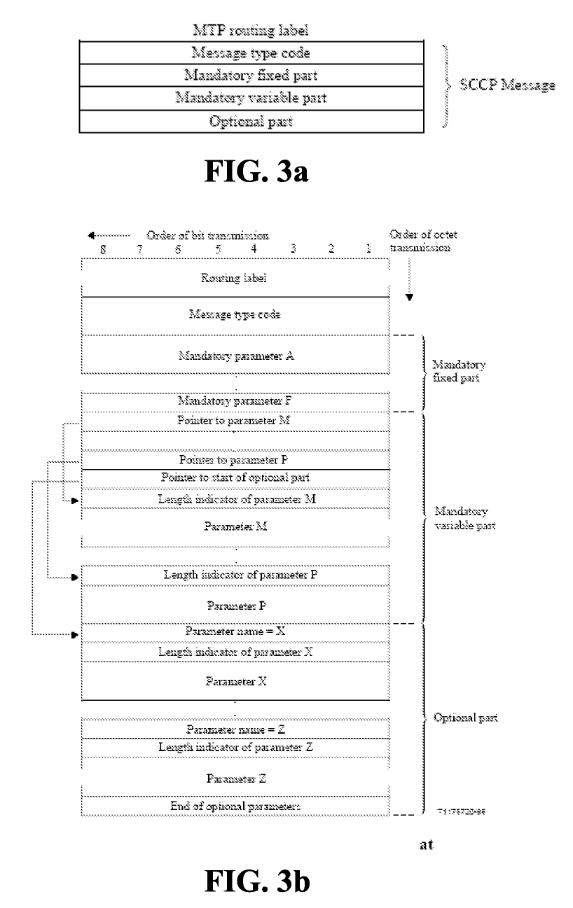

An example of an SCCP message is shown in FIG. 3a. The MTP routing label could follow the ANSI or ITU standard; they differ depending on the numbers of bytes used. Their usual format shown in FIG. 3b. Thus, it is possible to pick up all the necessary information by scanning inside a message at a fixed position, knowing which are the fixed and optional fields for each message type.

Cisco SCCP Protocol

Cisco SCCP (Skinny Client Control Protocol) is a Cisco proprietary, but open client-server, protocol. It is used between Cisco Call Manager and Cisco VoIP phones. The objectives in its creation were to reduce costs over H.323 and to create a simple protocol. Skinny is an easy to use architecture; complexity is demanded to Cisco Call Manager, which uses H.323 to communicate.

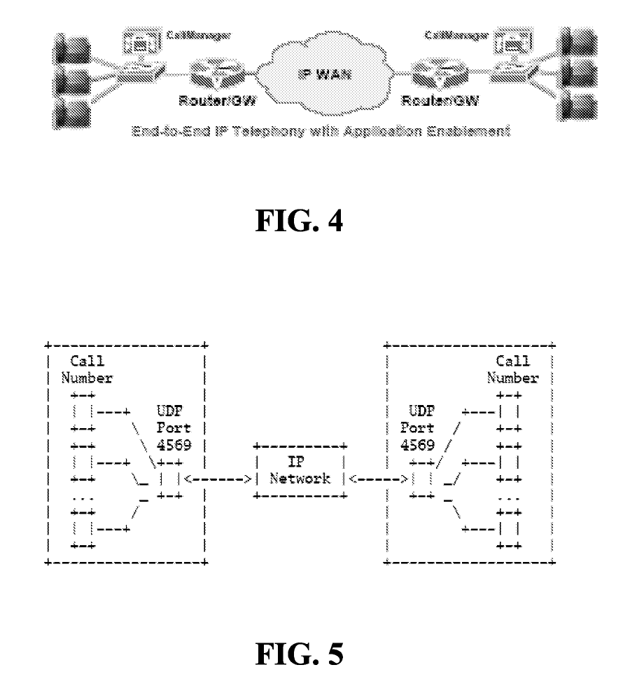

With reference to FIG. 4, the end stations (telephones) run a Skinny Client, which consumes less processing overhead. The Client communicates with the Call Manager using connection-oriented (TCP/IP-based) communication to establish a call with another H.323-compliant end station. Once the Call Manager has established the call, the two H.323 end stations use connectionless (UDP/IP-based) communication for audio transmissions.

Thus, the Skinny client uses TCP/IP to transmit and receive a call (using port number 2000), and uses UDP/RTP/IP for audio.

Within the same cluster, Cisco Call Managers use only Skinny to manage the call. Between different clusters, Cisco Call Managers use H.323. The Skinny messages are built as follows:
4B for length of the Skinny packet excluded length and reserved bytes;
4B reserved, all equal to 00;
4B for the MessageID;
optional, it depends by which message is sent.

More than one Skinny message could be sent in the same packet. The messages are not separated by any particular byte. It is only a sequence of bytes with a length, the reserved bytes, the message ID and optionally its parameters, length, reserved bytes, etc.

Skinny uses the Little Endian Format, so every number has to be converted.

There are many different MessagelDs in Cisco SCCP. However, the codes that are most useful for purposes of practicing the invention are the following:

| Code | Station Message ID Message |
|---|---|
| 0x0006 | Station Off Hook Message |
| 0x0007 | Station On Hook Message |
| 0x22 | Station Open Receive Channel Ack Message |
| 0x008A | Station Start Media Transmission |
| 0x008B | Station Stop Media Transmission |
| 0x008F | Station Call Information Message |
| 0x0095 | Station Start Session Transmission Message |
| 0x0096 | Station Stop Session Transmission Message |
| 0x105 | Station Open Receive Channel Message |
| 0x0106 | Station Close Receive Channel Message |
| 0x0111 | Station Call State Message |

For detection of the call phase, the following messages can be examined:
CallInfo for the INVITE, this message contains all the necessary information;
OpenReceiveChannelAck for the CONNECTION, this message contains no information useful for the csv file, so it will be picked up only by the rules, but not processed by the code;
CallState for the BYE, this message contains only the call_id.
   IAX Protocol

IAX (Inter-Asterisk exchange) is a 2in1 protocol that can handle both the control/signaling and the transport of media stream. It is a binary, peer to peer protocol.

According to the IAX Internet Draft, IAX is much more efficient for VoIP than the more complex protocols of SIP/MGCP plus RTP/RTCP which specify many more details than are strictly necessary to describe or transport a voice call. Further, because IAX is designed to be lightweight and VoIP-friendly, it consumes comparatively less bandwidth.

With reference to FIG. 5, IAX uses the same UDP port (4569 in version 2, and 5036 in version 1) for both its signaling and media messages. If a connection is established, there will always be audio. IAX uses a 15 bit Call Number to multiplex multiple streams over the UDP port number. Value 0 is a special number reserved on each host, and it means “Call number is unknown”.

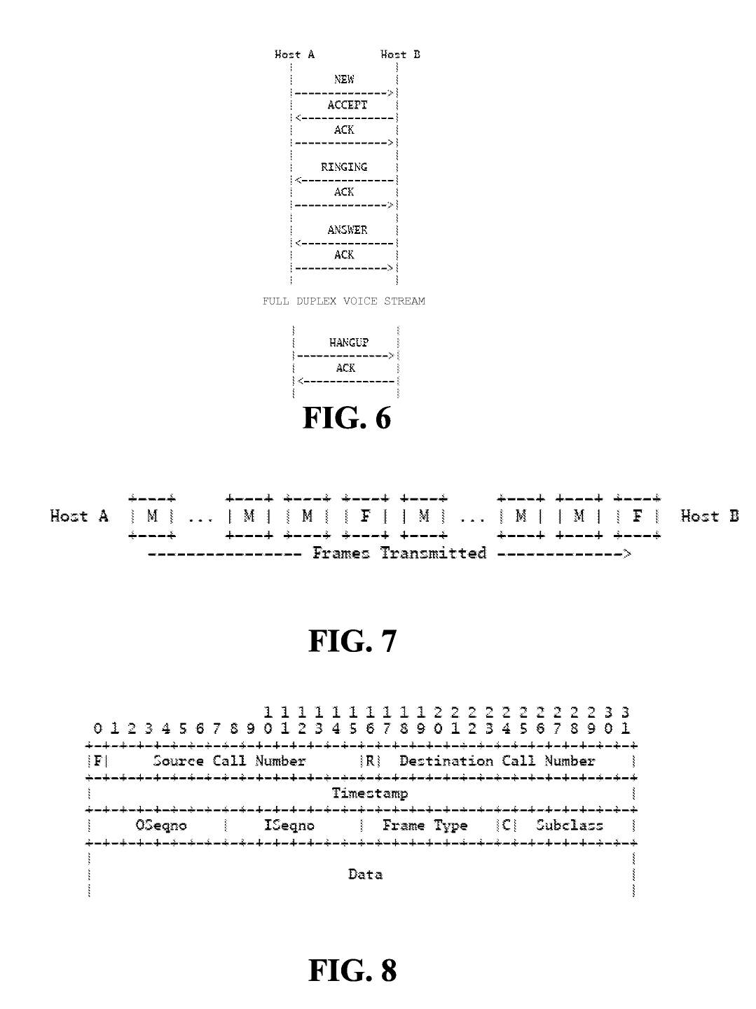

A sample of call setup and teardown, where A calls B and after the call A hangup, is shown in FIG. 6. A sample of simple one way IAX media flow is shown in FIG. 7. For a voice call, there will be 2 of these flows, in the 2 direction. The flow is made of:
M=IAX Mini Frames: 4 byte header, targets bandwidth efficiency;
F=IAX Full Frames: that includes synchronization.

The structure of a IAX frame is shown in FIG. 8. In FIG. 8:
F: full frame bit, if 1 is a full frame, if 0 different frame type;
R: retransmission bit, if 1 frame has been retransmitted;
Source Call Number: it is the call identifier for the caller;
Destination Call Number: it is the call identifier for the callee;
OSeqNo: outbound stream sequence number, it always begins with 0 and increseas monotonically. It is used to track the order of media frames;
ISeqNo: inbound stream sequence number, it is the next expected inbound stream sequence nr for the incoming media frame;
Frame Type: it identifies the class of message;
C: it determines how the subclass should be interpreted, if 1 subclass is identified as a power of 2, if 0 is identified as a simple 7 bit unsigned integer;
Subclass: according to the Frame type, it identifies the specific subclass.

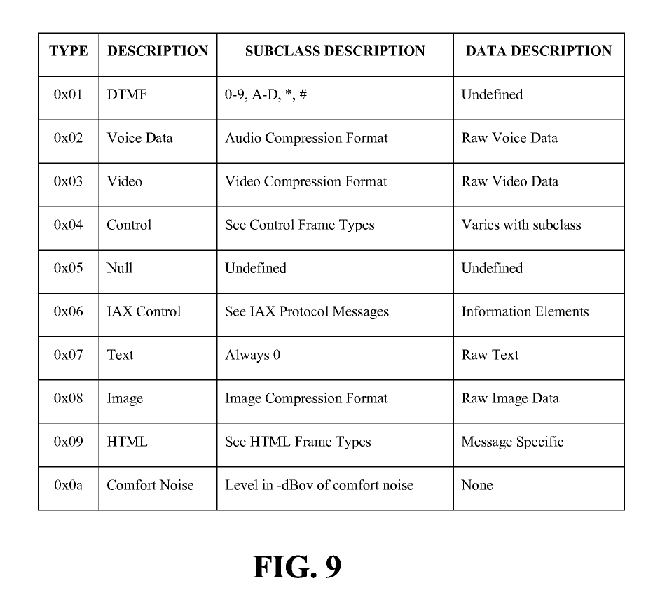

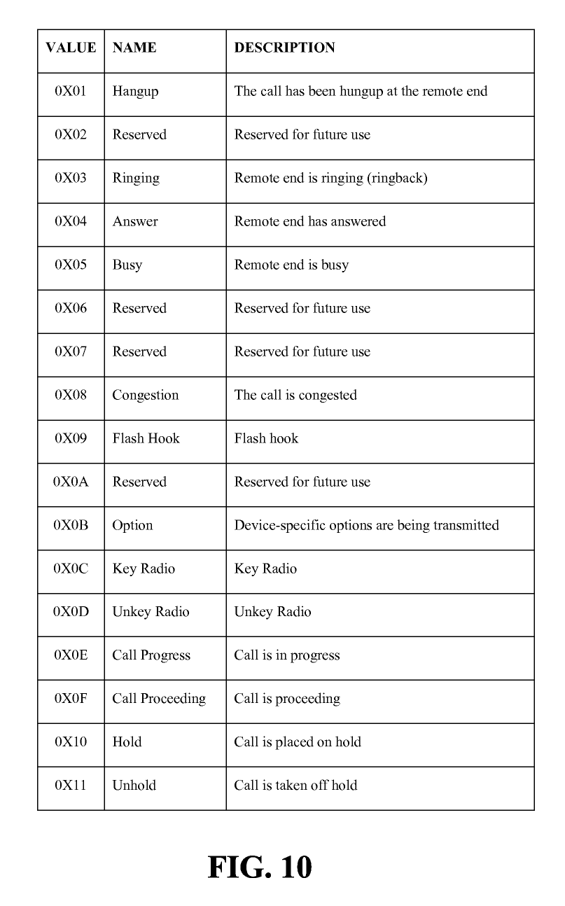

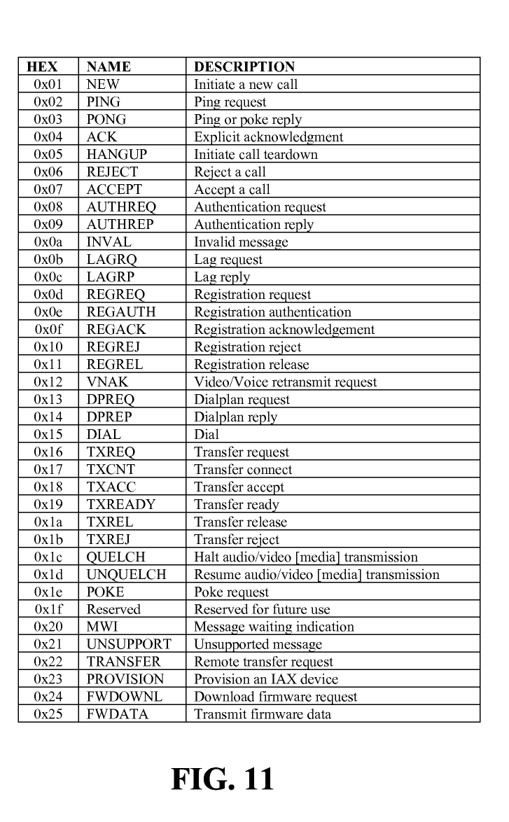

The table shown in FIG. 9 specifies Frame Type values. The table shown in FIG. 10 specifies Control Frame types. The table shown in FIG. 11 specifies IAX Control control frame types.

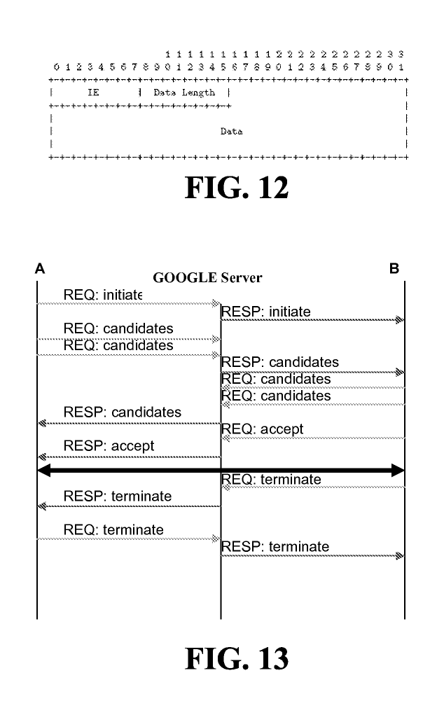

With reference to FIG. 12, some IAX Control Frames may have Information Elements. They are inside the data field. There are at least three octets: the first one is the IE field, the second one is the data length of the IE then we have the data.

For the call phases the messages chosen are:
IAX Control Frame NEW for the INVITE, this message contains all the information we need;
Control Frame ANSWER for the CONNECTION, this message contains only the call_id;
IAX Control Frame HANGUP for the BYE, this message contains only the call_id.
   GOOGLE TALK Protocol

GOOGLE TALK is a version of Jabber/XMPP protocols. All the communications are created through a “Google server,” and for this reason to track a call examining three messages is not enough. A different message containing all the information about the candidates (local and external IP addresses and info about their NAT) is needed.

All the message are in the form: Request/Response, and the first one is created by the user, the last one by the server.

The “Google server” is currently using a specific port number, but the software of the invention preferably monitors all the ports because this could change in the future. The users (candidates of a call) can use any possible port number. The different message types to pick up are:
GOOGLEinvite: it's the “initiate” message. The Request is made by the caller, instead the Response is received by the callee.
GOOGLEinvite_info: it's the “candidates” message. It is a Request when it sends its own information, Response when it receives info of the other candidate.
GOOGLEconnection: it's the “accept” message. The Request is created by who accept the call, the Response is received by who initiate the call.
GOOGLEbye: it's the “terminate” message. It could be sent from both side.

FIG. 13 illustrates communications between the caller, the Google Server, and the callee.

Skype Protocol

Skype is a VoIP application that uses a peer-to-peer proprietary protocol. Every packet exchanged is encrypted, so a clear comprehension of how Skype really works is difficult.

Behavior of Skype

When Skype is started, it creates a TCP connection with a Skype server (such as ui.skype.com at 212.72.49.131 with port number 80) in an effort to obtain an updated version of Skype (message in clear with a GET HTTP).

This is followed by a “login” phase. In this phase Skype creates a connection with a super node (SN), but it is indeterminate as to how it chooses the possible IP addresses. These are continuously contacted to check the availability during the entire time the application is running. When an available SN is found, Skype starts with this IP address a TCP connection. To check the state of the connection with this SN when it is not communicating, Skype sends a sort of “heartbeat” about every 2 minutes. The connection with the SN will be closed only at the end of the Skype application or in the situation that the SN itself stops the connection. In the latter scenario, Skype will create a connection with a new SN, choosing from the list that it has already checked. There are two different login types: automatic, called at the beginning of the application, or manual, when a user (with Skype running) logs off and want to login again.

After completion of the login, a buddy list is loaded. The buddy list is the list of the user's contacts. Every buddy list is specific for the computer where the application is used; if a user decides to login from another computer he generally must rebuild his buddy list.

At this point Skype is ready to receive a call or to create one. During a call, the software of the invention can recognize the different phases: the invite, the exchange of the keys for the encryption, a ringing zone and if a user decides to accept a call: the media stream and finally the hung up.

When a Skype user decides to make a call, Skype creates direct TCP connections between the end users (it is a peer to peer communication), with the local and external IP addresses. After this first connection, there is immediately an exchange of keys, needed for the encryption, using UDP packets.

While there may be no specific traffic to notify the caller of an “accept,” when a callee accepts the call, the exchange of media stream immediately starts with a first UDP packet from the callee to the caller.

When the caller or the callee decide to terminate the call, in the UDP stream there is a TCP packet sent by the user that hung up to the other user and a subsequent resulting TCP packet in the opposite direction in answer thereto.

Skype Structure

Skype Server

Skype creates a TCP connection with a Skype server (for example, ui.skype.com). This connection lasts for few seconds, and its purpose is to check if there is a newer version of the Skype application.

Usually it is a TCP stream of about ten packets, and they are the TCP SYN, ACK and, to close the connection, the TCP FIN. In this stream there are two HTTP packets included which bring the message to the server: an HTTP GET (with information about the system used and the message to look for “latest version”) and an HTPP 200 OK in answer.

The Skype server typically has a fixed IP address (currently 212.72.49.131), and to communicate it uses the HTTP port (80).

While this connection can be blocked, Skype then tries to connect to another server (currently 149.156.176.85) and eventually gives up its attempts to find a new version. In any case, Skype is usually able to log in without problems.

Using WHOIS, one can see that this IP address is owned by SKYPE-NL, which has a narrow range of IP address: 212.72.49.128-212.72.49.159.

Skype Login

For the login process Skype starts to send UDP packets (with a payload length of 18B) to many different IP addresses. The UDP packets use a source port chosen by the Skype application (it is a random number generated during the installation, but it is possible to change it inside the option panel).

There are three different types of response that are discernable:
available: the IP address contacted will become a possible supernode;
not available; and
no answer received.

The sequence of packets for the “available” answer is:

| Skype user | | SN to be |
|---|---|---|
| UDP - 18B | → | |
| | [symbol] | UDP - UB |
| UDP - 23B | → | |
| | [symbol] | UDP - 18B |

It is even possible to detect a positive answer with only the first and the last packets:

| Skype user | | SN to be |
|---|---|---|
| UDP - 18B | → | |
| | [symbol] | UDP - 18B |

Thus, the packets of 18B are the most significant. Also, these packets of 18B always have the third byte of the payload equal to “02”.

The above is supported even by the “not available” answer:

| | Skype user | | SN to be |
|---|---|---|---|
| | UDP - 18B | → | |
| | | [symbol] | UDP - UB |
| | UDP - 23B | → | |
| | | [symbol] | UDP - 58B |
| Or | | | |
| | UDP - 18B | → | |
| | | [symbol] | UDP - 18B |

In fact, with the above answers the TCP connection is never created.

In the last case, receiving no answer or receiving an ICMP “destination unreachable” by the IP address contacted, will result in simply discarding without further attempts on the same IP and passing to other IP addresses.

With the first IP that gives a positive answer, Skype creates a TCP connection (it does not use the Skype port number anymore).

After the SYN and ACK, Skype and the “SN to be” start a TCP stream; the IP address becomes the SN of the session if the first packets follow this sequence:

| Skype user | | SN |
|---|---|---|
| TCP PUSH, ACK - 14B | → | |
| | [symbol] | TCP PUSH, ACK - 14B |
| TCP PUSH, ACK - 35B | → | |

. . .

and the TCP stream lasts for the whole Skype session if there are no disconnections by the SN itself.

There may be no recurrent pattern in these packets in that the communication is already encrypted and the first two packets of 14B are a sort of “handshake”.

Blocking the TCP packets (with a payload of 14B and flags PUSH and ACK) prevents the login procedure. In this scenario Skype will not work at all.

The above login structure is the same for automatic and manual login. The only significant difference between automatic and manual login is the presence of a second TCP connection in the manual version.

When a user tries to login manually, it can be observed that while creating the TCP permanent connection with the SN, the Skype client always creates a second TCP connection with “betal.skype.net” (IP address 80.160.91.5 or 80.160.91.11 with port 33033). This TCP connection is temporary. After the TCP SYN and ACK, there is only an exchange of four TCP PUSH, ACK packets before ending the connection. The four TCP PUSH, ACK packets are:

| Skype client | | betal.skype.net |
|---|---|---|
| TCP PUSH, ACK - 5B | → | |
| Payload is 16 03 01 00 00 | | |
| | [symbol] | TCP PUSH, ACK - 5B |
| | | Payload is 17 03 01 00 00 |
| TCP PUSH, ACK - 389B | → | |
| Payload starts with | | |
| 16 03 01 00 | | |
| | [symbol] | TCP PUSH, ACK - 218B |
| | | Payload starts with |
| | | 17 03 01 00 |

It is probable that this TCP stream between the client and betal.skype.net is the procedure for the user authorization. In fact, we detect the request to digit manually the username and password only when the application is installed and when a manual login is needed. As soon as the user registers himself for the first time, his name and password are stored somewhere and no longer requested. Only when a user decides intentionally to log off and log in again, does this kind of traffic appear. This may be a protection built into Skype in order to hide Skype traffic as much as possible.

Blocking only the TCP traffic with a payload beginning with “16 03 01 00” and “17 03 01 00” results in an error message: “A critical error has occurred”. There is initially a window to “send error report”, followed by a window error message “Error: Could not connect to server”. These blocks avoid Skype working with a manual login, but are not exhaustive for the automatic login.

Heartbeat

Skype checks the TCP connection with the SN with a “heartbeat”. If the client and the SN do not need to communicate for a while, they start to exchange TCP packets (flags PUSH, ACK) with a payload of 2B every 2 minutes.

Call

To define the different phases of a call one can perform tests knowing exactly the IP address of the computers involved. With a well-known scenario (computers involved, times of invite, accept, hung up) one can determine the Skype call structure.

Invite

The invite could be identified with the first TCP packet sent by the caller to the callee in order to create a TCP connection. This connection is established between 2 local IP addresses, if both users are inside the same LAN, or between a local IP address of one user and the external IP address of the other.

The port number of the caller is not fixed, but the callee uses the Skype port number, because it is the one used to listen.

Inside the TCP stream one can see that the first TCP packets (with flag PUSH,ACK) are:

| Skype caller | | Skype callee |
|---|---|---|
| TCP PUSH, ACK - 14B | → | |
| | [symbol] | TCP PUSH, ACK - 14B |
| TCP PUSH, ACK - 71/72B | → | |

. . .

Thus, once again, one can see the “handshake” of 14B.

The caller usually communicates even with his SN after the invite.

Key Exchange

After the invite there is immediately a series of UDP packets with a payload of 4B. These packets use the Skype port number if they are local IP addresses. They are used to exchange the keys needed for the encryption. Every client sends his key to the local IP and external IP addresses. Then UDP packets are received in answer, and are always of 4B.

The payload can be used to identify these packets:
key sent: payload is XX XX XD 00;
answer received: payload is XX XX XD 01.

After this key exchange, UDP packets continue to be sent between the two end users, but their significance is unknown. However, after the accept, when the media stream starts, one can observe a different behavior.

Ringing Phase

This phase is approximately enclosed between the first TCP packet sent by the callee to the caller and the first UDP packet of 67B. One can observe that the caller creates other two TCP connections with auxiliary SNs. These connections are terminated just before the accept. In substance one can see the creation and termination of 2 TCP connections during the ringing phase. The structure of these two connections is identical:

4 TCP packets for the SYN and ACK;
4 TCP packets PUSH, ACK as:

| Skype caller | | Auxiliary SN |
|---|---|---|
| TCP PUSH, ACK - 14B | → | |
| | [symbol] | TCP PUSH, ACK - 14B |
| TCP PUSH, ACK - 15B | → | |
| | [symbol] | TCP PUSH, ACK - 14B |

2 UDP packets with a payload of 22B;
4 TCP packets for the FIN and ACK.

ACCEPT-MEDIA STREAM

The “accept” can be identified by the first UDP packet with a payload of 67B sent by the callee to the caller. The media stream is completely encrypted and it is composed of UDP packets with a payload of 67B.

Hung Up

The hung up coincides with the last UDP packet of 67B. The user that hangs up sends a TCP packet to the other client (using their direct TCP connection) of 16/17B and receives immediately after a TCP packet in answer of 13/14B. While their length is uncertain, there is a consistency in the difference of bytes between the hung up and the answer: 3B.

Closure of TCP and UDP Direct Connections—Heartbeats

After the hung up, TCP packets (PUSH, ACK) with a payload of 19B are exchanged between the end users in their direct TCP connection. This exchange lasts for about 10 seconds. Then we have 12 UDP packets of 3B, everyone terminating with the nibble “D”. Then we have the first heartbeat for the direct TCP connection between the end users (it works as the heartbeat between user and SN). Again it is possible to see another 12 UDP packets with the same characteristic as before and another heartbeat (the second one). Now we have ten UDP packets and a heartbeat (the third and last one).

It is possible to observe now the last twelve UDP packets of 3B, but this time instead of the heartbeat we have the closure of the direct TCP connection between the users involved in the call. After closing the TCP connection there aren't anymore UDP packets exchanged directly by the users. It is probable that the twelve or ten UDP packets are a tool for measuring the time and for creating the TCP heartbeat.

Software of the Detector

The detection software of the invention in one embodiment operates using a novel set of rules created for detecting the different phases of a call: the “invite”, when someone decide to start a call; the “connection” when a voice connection between end users is created and the last phase, the “bye”, when someone decides to terminate the call. This new set of rules can be compared by Snort against each packet.

When a packet fires an alert, this will store all the information needed for a billing purpose. To collect this data, the output plugins, a built-in function of Snort, can be modified. In this way the detection is not overloaded and one can use only a set of record tools to store all the information in a file in CSV format.

Snort itself provides some information about the packet picked up, as the IP addresses of origin and destination, the port numbers and time when the packet is generated.

What is needed to track a call is the real source and the real receiver (information stored inside the payload, following different protocols), the call reference number (to link every packet of the same call) and, when provided, the phone number.

One can create a CDR file for the billing database with all the information about the messages involved in the communications.

The software of the invention preferably builds a file, for each alerted packet, with:
time (“timestamp” already existing),
message of the alert (“msg” already existing),
protocol (“proto” already existing),
source MAC address (“ethsrc” already existing),
source IP address (“src” already existing),
source port (“srcport” already existing),
destination MAC address (“ethdst” already existing),
destination IP address (“dst” already existing),
destination port (“dstport” already existing),
source phone number or address (“from” new field),
source phone number (“from_nr” new field),
destination phone number or address (“to” new field),
destination phone number (“to_nr” new field),
call discriminator (“call_ID” new field).

In a second step, working directly on the database, it is possible to trace the session of the same communication, linking all the messages with the same Call_ID (or Call reference value).

Snort includes a function to create a CSV file; however, one must add the new fields and create the functions which operate to recognize the information needed inside a packet for each protocol and how to react. One can modify the file src/output-plugins/spo_csv.c (snort output plugins for csv file), adding 5 new fields:
“call_ID”, the reference of the session;
“from”, for the phone number or address of the caller;
“from_nr”, for the phone number of the caller;
“to”, for the phone number or address of the callee;
“to_nr”, for the phone number of the callee.

Inside the existing routine RealAlertCSV one can add the commands to take action when these different fields are selected, for the output plugins.

Call ID

When “call_ID” is obtained, the software discriminates between different protocol messages. For SIP messages, it searches the string “Call_ID:” inside the payload, the line after this string is the call reference value. For H.323, there is a fixed position in the payload where are the length of the call reference value and is real value, so the software can look inside the payload at the correct position. For MEGACO, the call reference value is the Context number, which is different for the caller and the callee. For MGCP the “Call_ID” is the “connection” field. For SCCP the “call ID” is composed by the “source local reference” and “destination local reference” (the INVITE has only the first field, in any way it is unique for each call). For SKINNY the call reference value is a parameter named “call identifier” in a fixed position for both INVITE and BYE phases. For IAX the Call_ID is split into two reference numbers: the first is the Source Call Number and the second is the Destination Call Number (the INVITE has only the Source Call Nr, because the Destination one has yet to be created). For GOOGLE TALK it is the session number, that is, the session “id” field.

From

When the software obtains a “from”, it discriminates between different protocol messages. For SIP messages it searches the string “From: ” inside the payload, and the line after this string is the SIP phone number or address of the caller. For H.323 it looks for the information element “calling party number” inside the payload. For MEGACO this information is optional and could be stored in different position depending by the packet that is picked up. It is the Termination ID for the INVITE Notify, INVITE Modify and CONNECTION. It is inside the SDP message for the INVITE Add. For MGCP as MEGACO it could be, if present, in one of several different fields; for INVITE Ntfy, INVITE Mdcx and CONNECTION “from” is the endpoint name, for INVITE Crcx it is inside the SDP message. For SCCP it is the “Calling Party Address” (optional field) of the INVITE message. For SKINNY this information is only inside the INVITE. It is the Calling Party Name of the Call Info Message. For IAX is present only in the INVITE. It is the optional Information Element “Name of Caller”. For GOOGLE TALK is the “initiator” field.

From_nr

When the software obtains “from_nr”, it discriminates between different protocol messages: For SKINNY this information is only inside the INVITE; it is the Calling Party of the Call Info Message. For IAX is present only in the INVITE. It is the optional Information Element “Calling Number”. For GOOGLE TALK is already implemented, but the final release that will contain the availability to call real “phone numbers” is not yet available.

To

When the software obtains “to”, it discriminates between different protocol messages. For SIP messages it searches the string “To:” inside the payload, and the line after this string is the SIP phone number or address of the callee. For H.323 it can look for the information element “called party number” inside the payload. For MEGACO it is stored only in two kinds of messages: INVITE Modify (inside the SDP payload) and INVITE Add (is the termination ID). For MGCP it is stored in INVITE Mdcx inside the SDP payload and in the INVITE Crcx (it is the endpoint name). For SCCP it is the value of “called party address” filed inside the INVITE (mandatory) and CONNECTION (optional). For SKINNY this information is only inside the INVITE. It is the Called Party Name of the Call Info Message. For IAX is present only in the INVITE. It is the Information Element “Number being called”. For GOOGLE TALK is the “to” field for GOOGLEinvite and GOOGLEinvite_info messages, for the GOOGLEconnection is the “from” field, the info is not present in the GOOGLEbye.

To_nr

When the software obtains “to_nr”, it discriminates between different protocol messages. For MEGACO it is the number dialed, in the “ds” field of INVITE Notify it is stored as dd/ce value. For MGCP is the number dialed. If the observed event is composed by a sequence of “d/x, d/x, d/x”, the “x” are the digit dialled in the “o:” field of the INVITE Ntfy. For SKINNY this information is only inside the INVITE. It is the Called Party of the Call Info Message. For GOOGLE TALK it is already implemented, but again the final release that will contain the availability to call real “phone numbers” is not yet available.

Routines
“call_ID” Routine

SIP

The routine looks for the string “Call-ID:” as defined in the standard. Set the new pointer at the first octet after that matched string and store all the payload until it finds the new carriage return character. Finally, it prints this field in the output file.

H.323

For this protocol, it is more difficult, because the software must first find the correct beginning of the protocol. Thus, the routine searches inside the payload until some conditions are satisfied, in order to verify the presence of the proper structure of the Q.931 protocol. These conditions are different for each different message type.

After that it sets the pointer at the beginning of the Q.931 header and store the value of the call reference value and finally it prints in the output file.

It isn't possible to use the same routine to print the value in the output file both for SIP and H323, because for SIP protocol we have to “translate” the call_id octet in ASCII code, in H323 the call reference value is the octet itself.

MEGACO

The “call_ID” information can be obtained only in few messages: MEGACOinvite_modify, MEGACOconnection and MEGACObye. This information is the ContextID field.

For the text encoding the software searches the string “Context=” (pretty text encoding) or “{C=” (compact text encoding) inside the payload. If found, the software stores the information in a string and prints it in the output file.

If not found, the software assumes it is a binary encoding. In this case, it has to search one of the following sequence of octets, depending on the length of the ContextID:

80 01 XX A3
80 02 XX XX A3
80 03 XX XX XX A3
80 04 XX XX XX XX A3
80 05 XX XX XX XX XX A3

where XX is the contextID. If found we store the context ID in a string and print in the output file. If not found, an error message is generated.

MGCP

The “callID” information can be obtained in all messages except in the MGCPinvite_ntfy. This information is the CallID field of the MGCP protocol.

The software looks inside the payload for the string “c:” or “C:” (it is case insensitive) and copies all the content from that point up to the end of the line in a string. Eventually it is printed in the output file. If not found an error message is generated.

SCCP

The CallID is composed by the “source local reference” and “destination local reference”.

The SCCPinvite has only the first one: the code sets the pointer at the beginning of the protocol inside the payload, that could follow the ANSI or ITU standard:
ANSI: Y3 YY YY YY YY YY YY YY 01 XX XX XX 02 (or 03) 02 . . .
ITU: Y3 YY YY YY YY 01 XX XX XX 02 (or 03) 02 . . .
Where:
   Y3 is the Service Information Octet: Y=subservice field and 3=Service Indicator of SCCP.
   sequence of YY is the Routing Label.
   01 is the message type code of CR (Connection Request).
   XX XX XX is the source local reference.
   02 or 03 are the protocol class.
   last octet 02 is the first pointer of variable mandatory field.

Knowing the number of bytes, the software can set the pointer at the beginning of the “source local reference” field and store the value.

The same procedure is followed for the other message (CONNECTION and BYE), when even the “destination local reference” has been obtained. The payload will be:
ANSI: Y3 YY YY YY YY YY YY YY 02 XX XX XX ZZ ZZ ZZ 02 (or 03) 00 (or 01) . . .
ITU: Y3 YY YY YY YY 02 XX XX XX ZZ ZZ ZZ 02 (or 03) 00 (or 01) . . .
Where:
   Y3 is the Service Information Octet: Y=subservice field and 3=Service Indicator of SCCP.
   sequence of YY is the Routing Label.
   02 is the message type code of CC (Connection Confirm).
   XX XX XX is the destination local reference.
   ZZ ZZ ZZ is the source local reference.
   02 or 03 are the protocol class.
   last octet (00 or 01) is the pointer to optional field.

The CallID information can be stored in the CSV file as:

XX XX XX: ZZ ZZ ZZ (without space).

SKINNY

The “Call_ID” information can be obtained from all the messages; it is the parameter named “Call Identifier” of a Skinny message.

The SKINNYinvite is the CallInfo message. The code is Ox8F. This message has always the length of 208 bytes (plus 8 bytes for length and reserved). The Call Identifier is the 6th parameter. The structure to look for is:

| | |
|---|---|
| D0 00 00 00 | Length |
| 00 00 00 00 | Reserved bytes |
| 8F 00 00 00 | Message ID |
| . . . (40B) | Calling Party Name |
| . . . (24B) | Calling Party |
| . . . (40B) | Called Party Name |
| . . . (24B) | Called Party |
| . . . (4B) | Line Instance |
| . . . (4B) | Call Identifier: the Call ID!!! |
| . . . (4B) | Call Type |
| . . . (40B) | Original Called Party Name |
| . . . (24B) | Original Called Party |

With this structure the software sets the pointer at the beginning of the payload and, considering that in a packet it is possible to have more than one Skinny messages, the software can scan the payload looking for the CallInfo Message. The scan is done looking for the pattern match of the first twelve bytes.

If the payload doesn't start with the CallInfo message, the length is converted in a proper format and saved, so it is possible to skip the right amount of bytes to read the new Skinny message. This scan is done until the message is found or the end of the payload.

When the CallInfo message is found, the pointer is moved in the payload just at the beginning of the Call Identifier, so it is possible to convert and save this value.

The procedure for the SKINNYbye is the same; the only difference is the structure of the message and its values. For the BYE we have the CallState Message. Its code is 0x111 and its length is 16 bytes (plus 8 bytes for length and reserved). The Call Identifier is the 3rd and last parameter, as the structure is:

| | |
|---|---|
| 10 00 00 00 | Length |
| 00 00 00 00 | Reserved bytes |
| 11 01 00 00 | Message ID |
| . . . (4B) | Call State |
| . . . (4B) | Line Instance |
| . . . (4B) | Call Identifier: the Call ID!!! |

IAX

The CallID is composed by the Source Call Number and Destination Call Number.

Considering that the IAX frame structure is that shown in FIG. 8, the code sets the pointer at the beginning of the protocol inside the payload. It stores the 1st two octets (skipping the 1st bit F) for the Source Call Nr and (if it is not a INVITE message) the Destination Call Nr (skipping the R bit).

Google Talk

The routine looks for the string “<session” and then, if found, look for the pattern “id=”. Set the new pointer at the first octet after that matched string, skip the “character and store all the payload until it finds the” that determines the end of the session id. Finally it prints this field in the output file.

“From” Routine

SIP

The procedure is the same as for call_ID, it changes only the string to search: “From:”.

H323

It is possible to fill in this field only in case of H323invite; in fact we have the “calling party number” only in the SETUP messages. For this reason the “from” field is directly set as blank in H323connection and H323bye. In the H323invite messages, the software can look for the information element which code is the octet 6C. The only rule we have is that the information elements are in numerical order, so we know that if the code of IE is bigger than 6C we can stop the search.

A sample of the structure of the code is:

```
  Position the pointer to payload.
  Read value of the pointer + 1, (this is the length of the call reference
value):
```

| | |
|---|---|
| if it is | 1 −> increment pointer by 4; |
| | 2 −> increment pointer by 5; |

```
  Now the pointer is at the first IE identifier.
  while (IE identifier<6C)
```

increment pointer by 1 (now it is at the length of IE);
read the value and increment the pointer by this value + 1

(IE=6C)?

YES: increment pointer by 1;

read length of IE and store;
increment pointer by 2 (now it is at the beginning of the

number);

the first half octet start with 1?

YES: skip to the next number (it is another field

that we don't need);

start a loop to store the number in the FROM string;

NO: FROM=‘\0’;

MEGACO

The “from” information can be obtained from all messages except MEGACObye. The data is stored inside the “Termination ID” field for all messages, except the MEGACOinvite_add, which is inside the SDP remote field. The termination ID is the number after the command name. Thus, depending on which message is picked up, the software can search the string:
for MEGACOinvite_notify “Notify=” (pretty text encoding) or “{N=” (compact text encoding), for MEGACOinvite_modify or MEGACOconnection “Modify =” (pretty text encoding) or “{MF=” (compact text encoding).

If found, store in a string all the char before the first space or “{” and print in the output file. If not found, the software we assume that is a binary encoding of the protocol, so it searches the sequence of octets:
A0 09 30 07 A0 00 81

After that there is one octet with the length of the Termination ID and the octets of the Termination ID. If not found, an error message is generated.

For the MEGACOinvite_add the software can check the SDP field. This is inside the REMOTE portion of MEGACO payload.

The IP info is the last field of “c=IN IP4 123.123.123.1” and port info is the 2nd field of “m=audio 2222 RTP/AVP 4”.

With these examples, the “from” is created as “123.123.123.1:2222”.

In this situation the software first sets the pointer after the string “Remote” or “,R{” (depending on which text encoding we have). After that it searches the string “c=” for the IP information and the string “m=” for the port information. Eventually the stored string is printed in the output file.

If not found, it is assumed that it is a binary encoding of the protocol. With this encoding the “SDP c field” sequence of octets to search is:
80 04 00 00 B0 08 A1 XX 04 (XX-2)

After this sequence is stored the c field and its length is (XX-2).

The IP information is after the second space (octet 20). The “SDP m field” sequence of octets to search is:
80 04 00 00 B0 0F A1 XX 04 (XX-2)

After this sequence is stored the m field and its length is (XX-2). The port information is after the first space (octet 20). If the sequence is not found, an error message is generated.

In the MEGACOinvite_notify message we have only one termination ID, in the other situations it could be possible to have more than one TerminationID, this are the Ephemeral Terminations . . . in this case we store all the terminations ID in the same “from” string.

MGCP

Tthe “from” information is obtainable from all messages except MGCPbye. For all the messages the “from” information is the endpoint name, except for the MGCPinvite_crcx which is the SDP portion of MGCP payload. The endpoint name is the 3rd field in the command line. So depending on which message was picked up, the software can search the command request verb, set the pointer after that, skip the transaction ID, set the pointer in the new position and start to store the endpoint name in a string. Finally print this string in the output file.

In the MGCPinvite_crcx the “from” information is inside the SDP portion of payload.

IP address can be found in the “o=” or “c=” lines (last field).

The port number can be found in the “m=” line (2nd field).

Example of SDP portion of payload:
¦v=0
¦o=23456789 987654321 IN IP4 123.123.123.1
¦s=-
¦c=IN IP4 123.123.123.1
¦m=audio 222 RTP/AVP 4

The software can look for the “o=” field if found we store the string, if not found it can look for the “c=” field and store its information. After that it looks for the “m=” field to save the port number in a different string. Finally it prints in the output file the IP address and the port number as 123.123.123.1:222. If the fields are not found an error message is generated.

SCCP

This information can be found only in the INVITE. The code sets the pointer at the beginning of the protocol inside the payload.
ANSI: Y3 YY YY YY YY YY YY YY 01 XX XXX 02 (or 03) 02 . . .
ITU: Y3 YY YY YY YY 01 XX XX XX 02 (or 03) 02 . . .
Where:
Y3 is the Service Information Octet: Y=subservice field and 3=Service Indicator of SCCP
sequence of YY is the Routing Label
01 is the message type code of CR (Connection Request)
XX XX XX is the source local reference
02 or 03 is the protocol class
last octet 02 is the first pointer of variable mandatory field

The “from” information is inside the optional field “Calling party address”. If it is present, its parameter code is 4. The “Calling address party” contains two fields: address indicator and address information. The address indicator is 1 octet:
8 7 6 5 4 3 2 1
bit 8=reserved for national use (1=national, 0=international)
bit 7=routing indicator (1=route on SSN, 0=route on GT)
bits 6-3=global title indicator
0=GT not included
   1=only nature of address indicator
   2=only translation type,
   3=translation type, numbering plan & encoding system
   4=as 3 plus nature of address indicator)
bit 2=SSN indicator (1=address contains a subsystem number)
bit 1=point code indicator (1=address contains signalling point code)

The address information is a mix of various elements, that occur in this order:
1. signalling point code (PC)
2. subsystem number (SSN)
3. global title (GT)

The from information is stored in the CSV file as:
PC number—SSN number—GT number (without space)

SKINNY

The “from” information is obtainable only in the INVITE and it is the parameter named “Calling Party Name”. The SKINNYinvite is the CallInfo message. The code is 0x8F. This message has always the length of 208 bytes (plus 8 bytes for length and reserved). The Calling Party Name is the 1st parameter. The structure to look for is:

| | |
|---|---|
| D0 00 00 00 | Length |
| 00 00 00 00 | Reserved bytes |
| 8F 00 00 00 | Message ID |
| . . . (40B) | Calling Party Name: the “from”!!! |
| . . . (24B) | Calling Party |
| . . . (40B) | Called Party Name |
| . . . (24B) | Called Party |
| . . . (4B) | Line Instance |
| . . . (4B) | Call Identifier |
| . . . (4B) | Call Type |
| . . . (40B) | Original Called Party Name |
| . . . (24B) | Original Called Party |

With this structure the software sets the pointer at the beginning of the payload and, considering that in a packet it is possible to have more than one Skinny message, the payload can be scanned to look for the CallInfo Message. The scan is done by looking for the pattern match of the first twelve bytes.

If the payload does not start with the CallInfo message, the length is converted in a proper format and saved, so it is possible to skip the right amount of bytes to read the new Skinny message. This scan is done until the message is found or the end of the payload.

When the CallInfo message is found, the pointer is moved in the payload just at the beginning of the Calling Party Name, so it is possible to save this string.

IAX

The From information is inside the IE “Name of caller” (IE=04) of the INVITE message. The structure of a NEW message is:
XX XX=full frame bit (=1 for the Full Frame)+Source Call Nr (15 bits)
00 00 or 80 00=retransmission bit+Destination Call Nr (15 bits)
4B timestamp
00=OSeqNo
00=ISeqNo
06=frametype
01=C+subclass
0B=IE Version
02=length of IE
00 02=value of IE
. . . =Other IE: 1B for IE type, 1B for Data Length and Data.

The code sets the pointer at the beginning of the first IE after the version. It compares the IE with 4 (value of IE Name of Caller), if the comparison is true the IE is found and the code start to store the value, otherwise it continues to scan the payload until it finds the IE or the payload ends.

To store the “from” information the code reads the length of the IE, then copy the data of the IE until it reaches its end.

Google Talk

The routine looks for the string “<session” and then, if found, look for the pattern “initiator=”. Set the new pointer at the first octet after that matched string, skip the “character and store all the payload until it finds the” that determines the end of the from information. Finally it prints this field in the output file.

“from_nr” Routine

SKINNY

The “from_nr” information is only in the INVITE and it is the parameter named “Calling Party”. The SKINNYinvite is the CallInfo message. The code is 0x8F. This message has always the length of 208 bytes (plus 8 bytes for length and reserved). The Calling Party Name is the 2nd parameter. The structure to look for is:

| | |
|---|---|
| D0 00 00 00 | Length |
| 00 00 00 00 | Reserved bytes |
| 8F 00 00 00 | Message ID |
| . . . (40B) | Calling Party Name |
| . . . (24B) | Calling Party: the “from_nr”!!! |
| . . . (40B) | Called Party Name |
| . . . (24B) | Called Party |
| . . . (4B) | Line Instance |
| . . . (4B) | Call Identifier |
| . . . (4B) | Call Type |
| . . . (40B) | Original Called Party Name |
| . . . (24B) | Original Called Party |

With this structure the software sets the pointer at the beginning of the payload and, considering that in a packet it is possible to have more than one Skinny message, the payload is scanned to look for the CallInfo Message. The scan is done by looking for the pattern match of the first twelve bytes.

If the payload doesn't start with the CallInfo message, the length is converted in a proper format and saved, so it is possible to skip the right amount of bytes to read the new Skinny message. This scan is done until the message is found or the end of the payload. When the CallInfo message is found, the pointer is moved in the payload just at the beginning of the Calling Party, so it is possible to save this string.

IAX

The From information is inside the IE “Calling number” (IE=02) of the INVITE message. The structure of a NEW message is:
XX XX=full frame bit (=1 for the Full Frame)+Source Call Nr (15 bits)
00 00 or 80 00=retransmission bit+Destination Call Nr (15 bits)
4B timestamp
00=OSeqNo
00=ISeqNo
06=frametype
01=C+subclass
0B=IE Version
02=length of IE
00 02=value of IE
. . . =Other IE: 1B for IE type, 1B for Data Length and Data.

The code sets the pointer at the beginning of the first IE after the version. It compares the IE with 2 (value of IE Calling number), if the comparison is true the IE is found and the code start to store the value, otherwise it continues to scan the payload until it finds the IE or the payload ends. To store the “from_nr” information the code reads the length of the IE, then copy the data of the IE until it reaches its end.

“to” Routine

SIP

The procedure is the same as for call_ID, only it changes the string to search: “To:”.

H323

It is possible to fill in this field only in case of H323invite, in fact we have the “called party number” only in the SETUP messages. For this reason the “to” field is directly set as blank in H323connection and H323bye. In the H323invite messages, the software can look for the information element which code is the octet 70. The only rule is that the information elements are in numerical order, so if the code of IE is bigger than 70 the search can be stopped.

The following is a sample of the structure code:
I have the pointer to payload.

Read value of the pointer+1, (this is the length of the call reference value):

| | |
|---|---|
| if it is | 1 −> increment pointer by 4; |
| | 2 −> increment pointer by 5; |

```
  Now the pointer is at the first IE identifier.
  while (IE identifier<70)
```

increment pointer by 1 (now it is at the length of IE);
read the value and increment the pointer by this value + 1

(IE=70)?

YES: increment pointer by 1;

read length of IE and store;
increment pointer by 2 (now it is at the beginning of the

number);

start a loop to store the number in the TO string;

NO: TO=‘\0’

MEGACO

The “to” information is only in the MEGACOinvite_modify and in MEGACOinvite_add messages. In the MEGACOinvite_modify message the information of the callee is inside the SDP message. The SDP message is inside the “Remote” portion of the MEGACO payload. IP info is the last field of “c=IN IP4 123.123.123.1” and port info is the 2nd field of “m=audio 222 RTP/AVP 4”. With these examples “to” is created as “123.123.123.1:222”.

The software looks for “Remote” or “,R{” (depending on the text encoding). It sets the pointer after this point and starts to search the “c=” field, store the IP info, search the “m=” field, store the port info.

If Remote not found, it is assumed that there is a binary encoding and the software looks for the sequence of octets:
80 04 00 00 B0 08 A1 XX 04 (XX-2) for the “SDP c field”: the IP address is after the second space (octet 20),
80 04 00 00 B0 0F A1 XX 04 (XX-2) for the “SDP m field”: the port number is after the first space (octet 20).

and stores the info in a string to be printed in the output file at the end. If the sequences are not found we have an error message.

In the MEGACOinvite_add the information of the callee is the termination ID. For the text encoding we search the value after the string “Add=” or “{A=”. For the binary encoding we look for the sequence of octets:
A0 09 30 07 A0 81

After that the software has one octet with the length and the octets of the Termination ID itself.

MGCP

The “to” information is only in the MGCPinvite_mdcx and MGCPinvite_add messages. In the MGCPinvite_mdcx message the information of the callee is inside the SDP portion of payload. IP address can be found in the “o=” or “c=” lines (last field), while the port number is the 2nd field of “m=” line. In the MGCPinvite_add message the information of the callee is the endpoint name. It is the string in the command line after the name of request verb and the transactionID.

SCCP

This information is present in the INVITE (mandatory) and CONNECTION (optional). For the INVITE we have, following as always a different number of bytes for the ANSI standard than the ITU standard; the Called party address in the mandatory portion of payload.
ANSI: Y3 YY YY YY YY YY YY YY 01 XX XX XX 02 (or 03) 02 ZZ ** ** ** ** ** . . .
ITU: Y3 YY YY YY YY 01 XX XX XX 02 (or 03) 02 ZZ ** ** ** ** **. . .
Where:
   Y3 is the Service Information Octet: Y=subservice field and 3=Service Indicator of SCCP
   sequence of YY is the Routing Label
   01 is the message type code of CR (Connection Request)
   XX XX XX is the source local reference
   02 (or 03) is the protocol class
   02 is the pointer to the called party address
   ZZ is the pointer to the optional part
   ** ** ** . . . is the called party address

For the CONNECTION the Called party address can be obtained from the optional portion of payload:
ANSI: Y3 YY YY YY YY YY YY YY 02 XX XX XX ZZ ZZ ZZ 02 (or 03) 01 . . .
ITU: Y3 YY YY YY YY 02 XX XX XX ZZ ZZ ZZ 02 (or 03) 01 . . .
Where:
   Y3 is the Service Information Octet: Y=subservice field and 3=Service Indicator of SCCP
   sequence of YY is the Routing Label
   02 is the message type code of CC (Connection Confirm)
   XX XX XX is the destination local reference
   ZZ ZZ ZZ is the source local reference
   02 or 03 is the protocol class
   last octet 01 is the pointer to the optional part (if present)

We consider only the case with last octet=01 . . . With no optional part there would not be a called party address.

“To” information is inside the mandatory field “Called party address”. After the octet with its length, the Called party address contains 2 fields: address indicator and address information. The address indicator is 1 octet:
8 7 6 5 4 3 2 1
bit 8=reserved for national use (1=national, 0=international)
bit 7=routing indicator (1=route on SSN, 0=route on GT)
bits 6-3=global title indicator
   0=GT not included,
   1=only nature of address indicator,
   2=only translation type,
   3=translation type, numbering plan & encoding system,
   4=as 3 plus nature of address indicator)
bit 2=SSN indicator (1=address contains a subsystem number)
bit 1=point code indicator (1=address contains signalling point code)

The address information is a mix of various elements that occur in this order: signalling point code (PC), subsystem number (SSN) and global title (GT). The To information is stored as:
PC number—SSN number—GT number (without space)

SKINNY

The “to” information is only in the INVITE and it is the parameter named “Called Party Name”. The SKINNYinvite is the CallInfo message. The code is 0x8F. This message has always the length of 208 bytes (plus 8 bytes for length and reserved). The Called Party Name is the 3rd parameter. The structure to look for is:

| | |
|---|---|
| D0 00 00 00 | Length |
| 00 00 00 00 | Reserved bytes |
| 8F 00 00 00 | Message ID |
| . . . (40B) | Calling Party Name |
| . . . (24B) | Calling Party |
| . . . (40B) | Called Party Name: the “to”!!! |
| . . . (24B) | Called Party |
| . . . (4B) | Line Instance |
| . . . (4B) | Call Identifier |
| . . . (4B) | Call Type |
| . . . (40B) | Original Called Party Name |
| . . . (24B) | Original Called Party |

With this structure the pointer is set at the beginning of the payload and, considering that in a packet it is possible to have more than one Skinny message, we scan the payload looking for the CallInfo Message. The scan is done looking for the pattern match of the first twelve bytes.

If the payload doesn't start with the CallInfo message, the length is converted in a proper format and saved, so it is possible to skip the right amount of bytes to read the new Skinny message. This scan is done until the message is found or the end of the payload.

When the CallInfo message is found, the pointer is moved in the payload just at the beginning of the Called Party Name, so it is possible to save this string.

IAX

The To information is inside the IE “Called number” (IE=01) of the INVITE message. The structure of a NEW message is:
XX XX=full frame bit (=1 for the Full Frame)+Source Call Nr (15 bits)
00 00 or 80 00=retransmission bit+Destination Call Nr (15 bits)
4B timestamp
00=OSeqNo
00=ISeqNo
06=frametype
01=C+subclass
0B=IE Version
02=length of IE
00 02=value of IE
. . . =Other IE: 1B for IE type, 1B for Data Length and Data.

The code sets the pointer at the beginning of the first IE after the version. It compares the IE with 1 (value of IE Called number), and if the comparison is true the IE is found and the code starts to store the value; otherwise it continues to scan the payload until it finds the IE or the payload ends.

To store the “to” information the code reads the length of the IE, then copies the data of the IE until it reaches its end.

GOOGLE Talk

The routine looks for the string “<iq ” and then, if found, looks for the pattern “to=” (for GOOGLEinvite and GOOGLEinvite_info) or “from=” (for GOOGLEconnection). The new pointer is set at the first octet after that matched string; the routine skips the “character and stores all the payload until it finds the” that determines the end of the “to” information. Finally it prints this field in the output file.

“to_nr” Routine

MEGACO

This information is only in the message MEGACOinvite_notify. After the search of “dd/ce”, the phone number is the string following “ds=”, both for the 2 text encoding. For the binary encoding, the event “dd/ce” is the sequence of octets:
80 04 00 04 00 04 or 80 04 00 06 00 04.

The number is the YY YY inside the sequence:
80 02 00 01 A1 XX 04 (XX-2) YY YY YY . . .
where (XX-2) is the length of the phone number.

MGCP

This information is only in the message MGCPinvite_ntfy.

An example of this message is:
¦NTFY . . . MGCP 1.0
¦o: d/5, d/0, d/0, d/1,

The above means that the number 5001 is dialled. The routine looks for the string “o:” and there it sets the pointer. If found the software scans the entire payload from the pointer until the first end of line. All the digits after “d/” and before the “,” or “\n” (end of line) are stored.

SKINNY

The “to_nr” info is obtainable only from the INVITE and it is the parameter named “Called Party”. The SKINNYinvite is the CallInfo message. The code is 0x8F. This message has always the length of 208 bytes (plus 8 bytes for length and reserved). The Called Party is the 4th parameter. The structure to look for is:

| | |
|---|---|
| D0 00 00 00 | Length |
| 00 00 00 00 | Reserved bytes |
| 8F 00 00 00 | Message ID |
| . . . (40B) | Calling Party Name |
| . . . (24B) | Calling Party |
| . . . (40B) | Called Party Name |
| . . . (24B) | Called Party: the to_nr!!! |
| . . . (4B) | Line Instance |
| . . . (4B) | Call Identifier |
| . . . (4B) | Call Type |
| . . . (40B) | Original Called Party Name |
| . . . (24B) | Original Called Party |

With this structure the pointer is set at the beginning of the payload and, considering that in a packet it is possible to have more than one Skinny message, the software scans the payload looking for the CallInfo Message. The scan is done by looking for a pattern match of the first twelve bytes.

If the payload does not start with the CallInfo message, the length is converted into a proper format and saved, so it is possible to skip the right amount of bytes to read the new Skinny message. This scan is done until the message is found or the end of the payload. When the CallInfo message is found, the pointer is moved in the payload to the beginning of the Called Party, so it is possible to save this string.

The system and method can use essentially the same principles taught above to decode any encrypted messages that are sent to establish a VoIP call. This can be accomplished by using one of two alternative methods, or a combination thereof. In accordance with a first method, specific patterns to establish a call or login processes are examined, and the information gained is acted upon. In accordance with a second method, pre-processing is used that decodes the basic information so that it can be processed using the detection methods set forth above.

Action Taken After Detection

A novel set of rules and responses have been created in order for the software to block calls. The basic sequence of actions is as follows. The software starts reading the set of rules; the software reads the packet on the network and compares it with the rules; and, if an alerts is triggered by a packet, the appropriate action is taken.

To stop a call two different actions can be used depending upon the transport protocol used by the voice protocol. If the voice protocol depends upon the use of TCP, a TCP RESET will suffice to stop the call. If the voice protocol depends upon the use of UDP, a new packet must be created to block the call.

In order to create a proper response to block a call on UDP, a “fake” message is needed: a BYE (if the alert is fired by a connection message) or a CANCEL (if it is fired by an invite message). This reaction is created by a new flexible response, which is different for each protocol.

Inside the packet there is only information about the users' source and destination, the users' MAC address, IP address, port and specific payload. A packet sent over the internet preferably does not contain any information about the software of the invention, and so it looks like an original packet sent by one user.

Blocking Skype requires a different approach than that set forth above. Because all data is encrypted, it is important to block the login, thereby blocking all possibilities of creating a call. The packets to block for the login are TCP packets with flags ACK and PUSH. To ensure a better result, the heartbeat and the Skype website should also be blocked. The heartbeat can be blocked by blocking TCP packets with flags ACK and PUSH. To block the website, it is necessary to block the HTTP packets, when a page is requested containing “skype” as the host.

Another possible action that can be taken by the software of the invention is to record the VoIP call. Once an alert is triggered, indicating the setting up of a call (following the same structure as explained above), a recording routine can begin to log all the media packets generated in the call, thereby tracking the session. Thereafter the audio/video of the stored media session can be decompressed using an appropriate decompression codec. Voice recording (or other IP Packet payload collection) will pick-up encrypted payloads, which may left undecrypted by the detector or may be decrypted in accordance with known decryption methods.

The software of the invention may be configured to perform its functions in a discrete, non-intrusive or invisible manner which does not interrupt or introduce substantial latency into the network into which it is deployed. It can be used in intelligence systems where strategically placed detectors, typically having a footprint of 1 rack unit each, with a primary interface and data storage facility, are capable of continuous monitoring of IP streams, allowing or disallowing traffic according to requirements, identifying a defined occurrence within a VoIP session, tracking identification elements such as caller ID, IP address, and MAC address within a VoIP session to provide forensic data, selectively filtering or terminating the VOIP session, and recording a VoIP session.

The system and methods may be used to perform true IP filtration, control, tracing, and undetectable manipulation by any authorized party empowered to police a network environment. It can be used to guarantee network security and Quality of Service (QoS), with dynamic levels of control for voice, video and data over IP data networks.

The system and methods may be used to assist State Telecommunications Regulators operating in regulated and restricted market places to recover lost revenue by capturing and recovering unauthorized grey traffic which costs governments and voice carriers millions of dollars in lost revenue.

Detailed records may be made individually searchable based upon one or more fields therein, including but not limited to:
Actual IP address initiating the call/event/change or spoof IP address
Actual IP address receiving the call/event/change or spoof IP address
Actual Mac address initiating the call/event/change or spoof Mac address
Actual Mac address receiving the call/event/change or spoof Mac address
Actual telephone number initiating the call/event/change or spoof telephone address
Actual telephone number receiving the call event/change or spoof telephone address
Actual email address initiating the call event/change or spoof email address
Actual email address receiving the call/event/change or spoof email address
Time the call/event was initiated/change or spoof time of call
Time the call/event was connected/change, delay or spoof time of call
Time the call/event was disconnected/change or spoof time of call
Geographic location of IP addresses/suspect can be produced in some cases through registries

The system and methods may be used to selectively filter data traffic so as to allow “identified as authorized” traffic and to disconnect “identified as un-authorized” traffic. In this respect, it may be used to allow only authorized protocols to transcend the network and disconnect other protocols. This selective filtering is particularly advantageous for filtering VOIP and/or music, video, or P2P streaming.

The system and methods may be used to detect and manipulate data types associated with computer games or online gambling, e.g., by for blocking or distorting such traffic and/or prevent online logins.

The system and methods may be used to block or allow instant messaging. Furthermore, many software programs such as soft phones provide multiple communication means, such as VoIP plus text messaging. The system and method may be used to disallow data from such programs while allowing text messaging, or vice versa. The system and methods may likewise be used to stop video transmissions but allow/block/add latency to text or IM messaging. The system and method may be used to block or allow specific access to particular URLs or websites, and/or provide a track & trace function for such access. The system and methods may be used to detect, block, and/or allow super nodes, such as Skype super nodes, within a network.

While the invention has been particularly shown and described with reference to a preferred embodiment thereof, it will be understood by those skilled in the art that various changes in form and details may be made therein without departing from the spirit and scope of the invention. For example, by changing the rules and applying the appropriate action, applications other than the those specifically discussed above which communicate over a network can be logged, recorded, or blocked, as required.

1. A method for detecting and reporting data traffic of a specific type on a network, comprising:
using a detector connected to said network to identify a set of data packets traveling across said network that conform to at least one signature describing data complying with a voice-over-IP protocol;
using said detector to create a record of data associated with said set of data packets that conform to said signature describing data complying with a voice-over-IP protocol; and,
using said detector to transfer said record to an external computing device.

2. The method in accordance with claim 1, wherein said voice-over-IP protocol comprises at least one protocol selected from the group consisting of: SKYPE, SIP, H323, Megaco, MGCP, Skinny, SCCP, IAX, Google Talk, and XMPP.

3. The method in accordance with claim 1, wherein said external computing device comprises a third-party billing system.

4. The method in accordance with claim 1, wherein said record of data associated with said set of data packets comprises a record containing one or more fields selected from the set of fields consisting of: a field for duration of call, a field for an identification of a calling party, and a field for an identification of a call recipient.

5. The method in accordance with claim 1, wherein said record of data associated with said set of data packets comprises a recording of said set of data packets that conform to at least one voice-over-IP protocol.

6. The method in accordance with claim 1, wherein said record of data associated with said set of data packets comprises data a subset of said set of data packets that conform to at least one voice-over-IP protocol.

7. The method in accordance with claim 1, wherein said external computing device comprises an external forensic analysis system.

8. The method in accordance with claim 1, wherein said step of using said detector to transfer said record to said external computing device comprises transferring said record indirectly to said external computing device.

9. The method in accordance with claim 1, wherein said detector is directly connected to said network.

10. The method in accordance with claim 1, wherein said at least one signature describing data conforming to a voice-over-IP protocol comprises a plurality of signatures describing data conforming to a plurality of voice-over-IP protocols.

11. The method in accordance with claim 1, wherein said third-party billing system comprises a billing system associated with a taxing authority or a service provider.

12. A method for detecting and manipulating data traffic of a specific type on a network, comprising:
using a detector connected to said network to identify a set of data packets traveling across said network that conform to at least one signature describing data complying with a voice-over-IP protocol; and,
using said detector to manipulate said set of data packets.

13. The method in accordance with claim 12, wherein said step of using said detector to manipulate said set of data packets comprises using said detector to prevent transmission of said set of data packets.

14. The method in accordance with claim 12, wherein said step of using said detector to manipulate said set of data packets comprises using said detector to divert said set of data packets.

15. The method in accordance with claim 12, wherein said step of using said detector to manipulate said set of data packets comprises using said detector to alter said set of data packets.

16. The method in accordance with claim 15, wherein said step of using said detector to alter said data packets comprises using said detector to delete information from said set of data packets.

17. The method in accordance with claim 15, wherein said step of using said detector to alter said data packets comprises using said detector to add information to said set of data packets.

18. The method in accordance with claim 12, wherein said step of using said detector to manipulate said set of data packets is performed selectively based upon a sender's IP address.

19. The method in accordance with claim 12, wherein said step of using said detector to manipulate said set of data packets is performed selectively based upon a recipient's IP address.

20. The method in accordance with claim 12, wherein said step of using said detector to manipulate said set of data packets is performed selectively based upon a sender's MAC address.

21. The method in accordance with claim 12, wherein said step of using said detector to manipulate said set of data packets is performed selectively based upon a recipient's MAC address.

22. The method in accordance with claim 12, wherein said step of using said detector to manipulate said set of data packets comprises adding latency to said set of data packets.

23. The method in accordance with claim 12, wherein said step of using said detector to manipulate said set of data packets comprises altering said set of data packets so as to interfere with at least one function associated with said voice-over-IP protocol.

24. The method in accordance with claim 23, wherein said step of altering said set of data packets so as to interfere with at least one function associated with said voice-over-IP protocol comprises altering said set of data packets so as to interfere with at least one function associated with said voice-over-IP protocol and to allow at least one other function associated with said voice-over-IP protocol.

25. A method for detecting and reporting data traffic of a specific type on a network, comprising:
using a detector connected to said network to identify a set of data packets traveling across said network that conform to at least one signature describing data complying with a data transmission protocol;
using said detector to create a record of data associated with said set of data packets that conform to said signature describing data complying with a data transmission protocol, said record including at least one field selected from the set of fields consisting of: a field describing an amount of data transmitted, a field describing a duration of data transmission, a field identifying a sender, or a field identifying a recipient; and,
using said detector to transfer said record to an external billing system.

26. A method for detecting and manipulating data traffic of a specific type on a network, comprising:
using a detector connected to said network to identify a set of data packets traveling across said network that conform to at least one signature describing data complying with a data transmission protocol; and,
using said detector to manipulate said set of data packets.

27. The method in accordance with claim 26, wherein said step of using said detector to manipulate said set of data packets comprises using said detector to prevent transmission of said set of data packets.

28. The method in accordance with claim 26, wherein said step of using said detector to manipulate said set of data packets comprises using said detector to divert said set of data packets.

29. The method in accordance with claim 26, wherein said step of using said detector to manipulate said set of data packets comprises using said detector to alter said set of data packets.

30. The method in accordance with claim 29, wherein said step of using said detector to alter said data packets comprises using said detector to delete information from said set of data packets.

31. The method in accordance with claim 29, wherein said step of using said detector to alter said data packets comprises using said detector to add information to said set of data packets.

32. The method in accordance with claim 26, wherein said step of using said detector to manipulate said set of data packets is performed selectively based upon a sender's IP address.

33. The method in accordance with claim 26, wherein said step of using said detector to manipulate said set of data packets is performed selectively based upon a recipient's IP address.

34. The method in accordance with claim 26, wherein said step of using said detector to manipulate said set of data packets is performed selectively based upon a sender's MAC address.

35. The method in accordance with claim 26, wherein said step of using said detector to manipulate said set of data packets is performed selectively based upon a recipient's MAC address.

36. The method in accordance with claim 26, wherein said step of using said detector to manipulate said set of data packets comprises adding latency to said set of data packets.

37. The method in accordance with claim 26, wherein said step of using said detector to manipulate said set of data packets comprises altering said set of data packets so as to interfere with at least one function associated with said data transmission protocol.

38. The method in accordance with claim 37, wherein said step of altering said set of data packets so as to interfere with at least one function associated with said data transmission protocol comprises altering said set of data packets so as to interfere with at least one function associated with said data transmission protocol and to allow at least one other function associated with said data transmission protocol.

39. The method in accordance with claim 26, wherein said at least one signature describing data complying with a data transmission protocol comprises a signature describing at least two characteristics associated with said signature.

40. The method in accordance with claim 26, further comprising the steps of:
using said detector to create a record of data associated with said set of data packets that conform to said signature describing data complying with a data transmission protocol; and,
using said detector to transfer said record to an external billing system.

41. The method in accordance with claim 40, wherein said record includes at least one field selected from the set of fields consisting of: a field describing an amount of data transmitted, a field describing a duration of data transmission, a field identifying a sender, or a field identifying a recipient.

42. The method according to claim 26, wherein said step of using a detector connected to said network comprises using a detector having a network interface card configured in listen-only mode such that it has no IP address or predetermined MAC address on the network.
